(19) United States
(12) Patent Application Publication
(10) Pub. No.: US 2018/0018661 A1
(43) Pub. Date: Jan. 18, 2018

(54) VIRTUAL POINT OF SALE

(71) Applicant: ENT. SERVICES DEVELOPMENT CORPORATION LP, Tysons, VA (US)

(72) Inventor: Wade MURPHY, Wellington (NZ)

(73) Assignee: ENT. SERVICES DEVELOPMENT CORPORATION LP, Tysons, VA (US)

(21) Appl. No.: 15/547,048

(22) PCT Filed: Jan. 27, 2015
(86) PCT No.: PCT/US15/13071

§ 371 Date: Jul. 27, 2017

(51) Int. Cl. G06Q 20/38; G06Q 20/12; G06Q 20/40

(52) U.S. Cl. CPC G06Q 20/3829; G06Q 20/4012; G06Q 20/12; G06Q 2220/00

(57) ABSTRACT

A portable device includes a communication interface to communicate with a consumer endpoint device, and a reader to receive a payment credential of a payment card detected by the portable device, to support a virtual point-of-sale (POS), card present online transaction between the consumer endpoint device and a merchant server. The portable device can establish a secure session with a host system using a cryptographic key, and send an authorization request comprising the payment credential in the secure session with the host system, the authorization request seeking authorization of payment for the online transaction.

### BACKGROUND

Online commerce activity (also referred to as eCommerce activity) continues to grow at a rapid rate. However, providing secure payment for online transactions continues to present challenges to both merchants and consumers. Fraudulent activity in online transactions can result in higher costs to both merchants and consumers.

### BRIEF DESCRIPTION OF THE DRAWINGS

Some implementations are described with respect to the following figures.

FIG. 1 is a block diagram of an example arrangement that includes a virtual point-of-sale (POS) engine that includes a portable device, according to some implementations.

FIG. 2 is a flow diagram of an example process of the virtual POS engine, according to some implementations.

FIGS. 3A-3D are various views of an example portable device according to some implementations.

FIGS. 4A-4B are block diagrams of components in an example portable device according to various implementations.

FIGS. 5A-5C are schematic diagrams of various information displayed in a user interface screen, according to some implementations.

FIG. 6 is a block diagram of an example logical architecture of an arrangement according to some implementations.

FIGS. 7A-7B depict a flow diagram of an example process according to further implementations.

### DETAILED DESCRIPTION

Providing secure online transactions can be difficult due to a number of factors. One such factor is that online transactions are frequently conducted as card-not-present (CNP) transactions. In a CNP transaction, a physical payment card is not present for inspection by a merchant. A physical payment card can include a credit card, a debit card, a smartcard that holds a payment credential, a smartphone that stores a payment credential, a user-wearable device that stores a payment credential, or any other card or electronic device that contains or stores a payment credential that may be used to purchase goods or services. A payment credential can refer to any information used to identify an account from which a payment can be made, such as an account at a bank, at a credit card issuer, or at any other entity.

The absence of the physical payment card increases the opportunity for fraud or misappropriation of a consumer's payment card data because the merchant has no ability to verify that the consumer is in possession of the payment card. In addition, payment card data is often transferred as clear text in traditional CNP transactions, which makes CNP transactions vulnerable to, for example, replay attacks. As the popularity and prevalence of online transactions continue to grow, the risk of payment card data being exposed to fraudulent activity also rises.

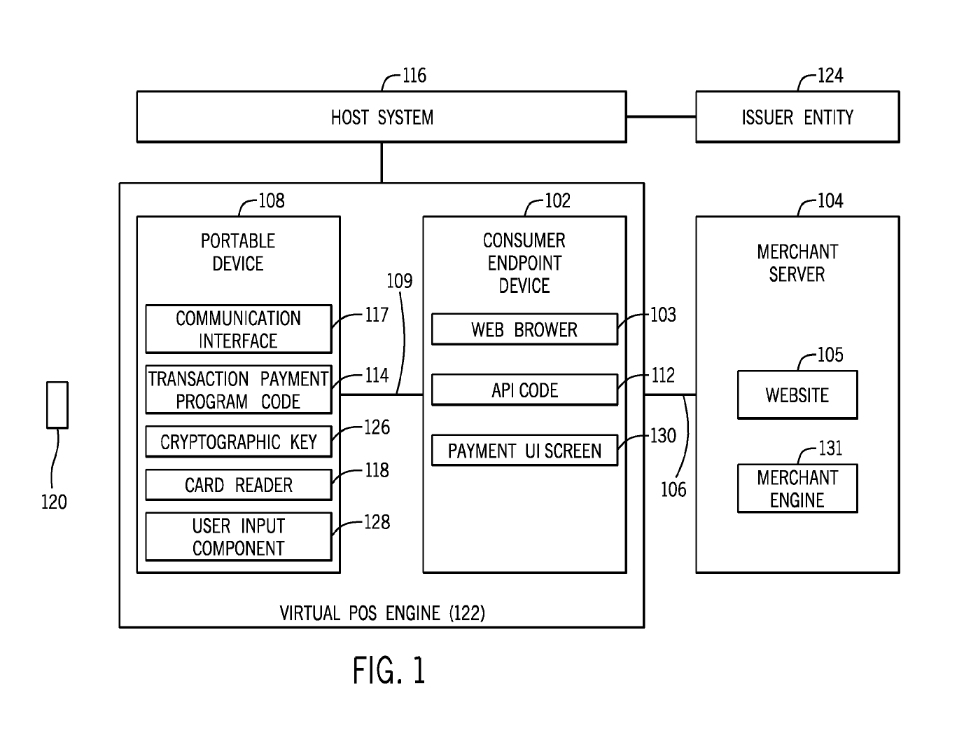

In accordance with some implementations of the present disclosure, techniques or mechanisms are provided to replicate a more secure retail point-of-sale (POS) experience for online transactions. As shown in FIG. 1, an online transaction can refer to a transaction conducted by a consumer, using a consumer endpoint device 102, with a remote online merchant server 104 provided by a merchant for the sale of goods or services. The online transaction can be performed between the consumer endpoint device 102 and the merchant server over a network 106, such as the Internet or other type of network. In an online transaction, the consumer endpoint device 102 and the merchant server 104 can be at remote locations.

A merchant server can refer to one or multiple server computers that are accessible by a consumer endpoint device to conduct an online transaction. In some examples, the merchant server can include a web server that provides a website 105 and a merchant engine 131, e.g. in the form of a servlet, API code, etc., that causes the system to effect a Card Present (CP) or Card Not Present (CNP) online transaction.

In the present disclosure, the term “engine” can refer to machine-executable instructions, or a combination of machine-executable instructions and processing hardware. Examples of processing hardware include a microprocessor, a core of a microprocessor, a microcontroller, an application specific integrated circuit (ASIC) device, a programmable gate array, and so forth.

Examples of consumer endpoint devices can include any or some combination of the following: a personal computer, a tablet computer, a smartphone, a user-wearable device (an electronic device worn on a person, such as on the wrist, on the face, etc.), or any other type of computing device. Although just one consumer endpoint device 102 and one merchant server 104 are shown in FIG. 1, it is noted that in other examples, multiple consumer endpoint devices and/or multiple merchant servers can be provided.

An online transaction can be conducted using a web browser 103 of the consumer endpoint device 102. The web browser 103 can access the website 105 of the merchant server 104 to establish a web session, in which the consumer (human user) can be presented with information relating to offerings (goods and/or services) from the merchant. The consumer can then select an offering for purchase, following which the consumer can select a payment control element (displayed in a display screen of the consumer endpoint device 102) to start the payment process for the online transaction.

In some implementations, two-factor authentication can be provided to effect a card present (CP) transaction (for making payment) in a virtual POS solution that enables a secure transaction experience between the consumer endpoint device 102 and the online merchant server 104. A “virtual POS transaction” can refer to a transaction that mimics a physically present, transaction as if conducted physically in person between a consumer and a merchant both located at the same location, e.g. in a physical retail store. A CP transaction can refer to a transaction in which the payment card is physically present and detectable.

A two-factor authentication can refer to an authentication process that is based on two factors, including (1) physical presentation of a payment card, and (2) knowledge of certain unique information, which can be information uniquely known to an authorized user such as a security code (e.g. personal identification number (PIN), a password, etc.), or other information. In other examples, a multi-factor authentication can be based on more than two factors.

In accordance with some implementations of the present disclosure, to avoid having to specially configure consumer endpoint devices to support virtual POS, card present online transactions, a separate portable device 108 can be provided that is able to interact with the consumer endpoint device 102 to perform a virtual POS, card present online transaction. The portable device 108 has a relatively small size, such as in the form of a key fob, a memory stick, or any other device that can be easily carried by a user, such as in a pocket, on a keychain, in a purse, and so forth. The portable device 108 can also be referred to as an accessory device, which is a device that is combined with another device, such as the consumer endpoint device 102, to perform specified tasks.

The portable device 108 can be connected over a wireless connection or a wired connection 109 to the consumer endpoint device 102. For example, the portable device can perform Bluetooth wireless communications, near-field communication (NFC) wireless communications, and so forth. As other examples, the portable device 108 can be plugged into a Universal Serial Bus (USB) port of the consumer endpoint device 102 or another port of the consumer endpoint device 102 to provide a wired connection. As yet another example, the portable device 108 can be connected over an electrical cable (e.g. USB cable or other type of cable) to the consumer endpoint device 102.

In the example of FIG. 1, the consumer endpoint device 102 includes an application programming interface (API) code 112, which provides an API to support communications between the portable device 108 and the consumer endpoint device 102. The API code 112 when executed by processing hardware in the consumer endpoint device 102 supports communications by a transaction payment program code 114 (in the portable device 108) with the merchant server 104 and a host system 116.

The API code 112 can be implemented as machine-executable instructions, such as in the form of software and may be installed in response to the detected connection between the portable device 108 and consumer endpoint device 102, via a software download from the host system 116. The transaction payment program code 114 can be implemented in the form of machine-executable instructions, such as firmware or software in the portable device 108. The transaction payment program code 114 is executable on processing hardware in the portable device 108.

The portable device 108 also includes a communication interface 117 to communicate with the consumer endpoint device 102. The communication interface 117 can be a wireless interface (e.g. NFC interface, Bluetooth interface, etc.) or a wired interface (e.g. USB interface, etc.).

The portable device 108 can also include a card reader 118 to read information of a physical payment card 120. In some examples, if the communication interface 117 is a wireless interface such as an NFC interface or a Bluetooth interface, then the communication interface 117 can also function as a card reader to receive information of the payment card 120, in which case a separate card reader 118 can be omitted.

A contact-based card reader 118 reads information of the payment card 120 when the payment card 120 is in physical contact with the card reader 118. For example, the card reader 118 can read an integrated circuit card (chip card) of the payment card 120.

Collectively, the portable device 108 and the consumer endpoint device 102 can form a virtual POS engine 122. The virtual POS engine 122 supports a virtual POS, card present online transaction.

Although reference is made to the virtual POS engine including the portable device 108 and the consumer endpoint device 102, it is noted that the virtual POS engine 122 can also include specific machine-executable instructions of the portable device 108 and the consumer endpoint device 102, such as the transaction payment program code 114 and the API code 112, along with processing hardware on which the respective code is executable.

The host system 116 can include a system that is accessible by the portable device 108 through the consumer endpoint device 102, and that can interact with an issuer entity 124 (e.g. a bank server, a credit card company server, etc.) who may issue a payment card 120 and authorize a request for payment for an online transaction. In some examples, the host system 116 can be located in a cloud. In other examples, the host system 116 can be a web server or other type of server accessible over a network such as the Internet. More generally, a host system is a system, made up of one or multiple computers, that interacts with the virtual POS engine 122 and the issuer entity 124.

As further shown in FIG. 1, the portable device 108 can also store a cryptographic key 126 that can be used to establish a secure session between the portable device 108 and the host system 116, for the purpose of authorizing payment for an online transaction between the consumer endpoint device 102 and the merchant server 104.

The portable device 108 further includes a user input component 128, and the consumer endpoint device 102 further includes a payment user interface (UI) screen 130, which are described further below.

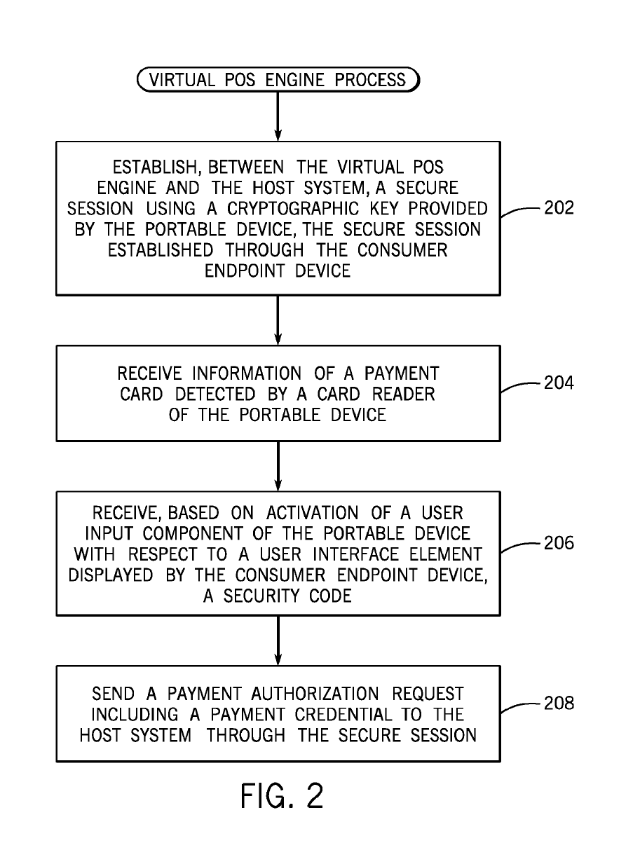

FIG. 2 is a flow diagram of a process according to some implementations. The process can be performed by the virtual POS engine 122 according to some implementations. The user of an electronic, online eCommerce merchant website may initiate a transaction by placing items to purchase in a digital, e.g. virtual, shopping cart. As used here, a “user” can mean a person performing or executing interactions, or a plurality of interactions, on the virtual POS engine 122. The merchant web server 104 shown in the example of FIG. 1 can include the merchant engine 131, e.g. in the form of a servlet, API code, etc, that causes the system to effect a virtual POS engine 122 terminal check and present various options for selection by the user (e.g. CNP and CP (contact or contactless (e.g. NFC)) options), or CNP option only for the purposes of conducting an online transaction.

The virtual POS engine 122 establishes (at 202), between the virtual POS engine 122 and the host system 116, a secure session using the cryptographic key 126 provided by the portable device 108. Establishing the secure session between the portable device 108 and the host system 116 can refer to encrypting data sent through the session using the cryptographic key 126. In addition, in some examples, establishing the secure session can further include checking the validity of the portable device 108, and other processes, as discussed further below.

The secure session is established through the consumer endpoint device 102, and more specifically, through the API provided by the API code 112 of the consumer endpoint device 102. The API provided by the API code 112 can include one or multiple API routines (machine-executable instructions) that can be invoked by the portable device 108 and the host system 116 to initiate or control the secure session.

The virtual POS engine 122 can present, e.g. display in a UI screen (e.g. 130 in FIG. 1), a prompt to enter payment credentials, e.g. payment card information via the portable device 108. In response to the user tapping or inserting the payment card 120 on the portable device 108, the virtual POS engine 122 receives (at 204) information of the payment card 120 that is detected by a reader of the portable device 108, where the reader can include the communication interface 117 or the card reader 118 of FIG. 1.

The virtual POS engine 122 can also prompt the user for input of a security code, which can include a PIN, a password, or any other information uniquely known to a user. In operation, the virtual POS engine 122 may present, e.g. prompt, for the security code via a UI screen (e.g. 130 in FIG. 1) of the consumer endpoint device 102.

The virtual POS engine receives (at 206), based on activation of the user input component 128 made with respect to a UI element displayed by the consumer endpoint device 102, the security code. The UI element can be displayed in the payment UI screen 130 displayed by the consumer endpoint device 102.

In some implementations, the portable device 108 is a simple device that does not include a display screen or a sophisticated user input mechanism. For example, the portable device 108 can be configured without a number pad (including keys or buttons for numbers 0-9, for example). Rather, the user input component 128 of the portable device 108 can include navigation buttons and a select button (which are examples of control buttons that are user-actuatable). The navigation buttons can be actuated to perform navigation of a cursor displayed in the payment UI screen 130 of the consumer endpoint device 102. The select button can be actuated to make a selection with respect to a UI element in the payment UI screen 130.

The payment UI screen 130 of the consumer endpoint device 102 can be considered a virtual U I screen for the portable device 108. The navigation and select buttons of the portable device 108 can be associated captive sensors in the portable device 108, which are able to detect user actuation of the navigation/select buttons. The captive sensors interact with a virtual element, such as a virtual number pad, displayed in the payment UI screen 130 of the consumer endpoint device 102. The virtual element, e.g. virtual number pad, can be invoked by the transaction payment program code 114 executing in the portable device 108.

A security mechanism can be provided to protect communication between the captive sensors of the portable device 108 and the virtual element of the payment UI screen 130. For example, the security mechanism can apply some form of message disruption (e.g. data encryption, data scrambling, etc.) between the captive sensors of the portable device 108 and the payment UI screen 130 of the consumer endpoint device 102. In another example, the number buttons on a virtual number pad can be randomized, such that the order of numbers entered in the number key pad is randomized before being communicated from the portable device 108 to the consumer endpoint device 102.

Activation of the user input component 128 with respect to the payment UI screen 130 can refer to activating the user input component 128 based on a user viewing the payment UI screen 130. For example, the user can use the navigation buttons to navigate a cursor displayed in the payment UI screen 130 to a desired number button, and can then activate the select button of the user input component 128 to activate that number button. In this manner, a user can use the combination of the user input component 128 and a payment UI screen 130 to enter a security code, such as a PIN, to be used for authorizing payment for the online transaction.

As further shown in FIG. 2, the virtual POS engine 122 sends (at 208) a payment authorization request to the host system 116. The payment authorization request includes the security code entered by the user using the user input component 128 and the payment UI screen 130, and a payment credential that is received as part of the information from the payment card 120. The payment authorization request is sent through the secure session between the portable device 108 and the host system 116.

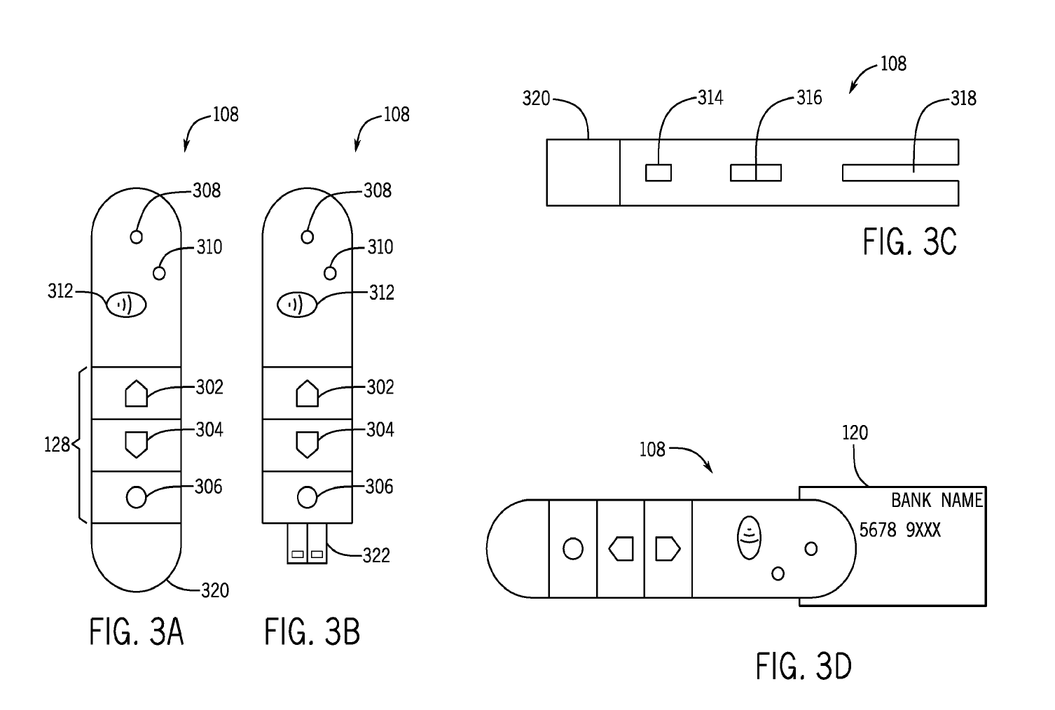

FIG. 3A is a front view of the portable device 108 according to some implementations. The user input component 128 includes navigation buttons 302 and 304 and a select button 306. Although just two navigation buttons are shown in FIG. 3A, it is noted that more than two navigation buttons can be provided in other examples. Also, there can also be other buttons in addition to the navigation buttons 302, 304 and the select button 306 in further examples.

In some examples, indicators 308 and 310 (e.g. such as in the form of light indicators) can be provided to indicate operational characteristics of the portable device 108. The indicator 308 can indicate (such as with different color light or with absence or presence of light) whether or not the portable device 108 is ready for operation, and the indicator 310 can indicate such as with different color light or with absence or presence of light) whether the portable device 108 is wirelessly connected (such as over a Bluetooth connection) with the consumer endpoint device 102. In other examples, less than two indicators can be provided, or more than two indicators can be provided.

A label 312 can also be provided on the portable device 108, to visibly indicate a general location on the portable device 108 where the payment card 120 can be tapped or brought into proximity for the portable device 108 to wirelessly read information of the payment card 120. If the portable device 108 performs contact-based reading of the payment card 120, then the label 312 can be omitted.

In some examples, the portable device 108 also includes a removable cover 320 that can be removed to expose a USB connector 322 (or other type of connector), as shown in FIG. 3B. The USB connector 322 can be plugged into a USB port of the consumer endpoint device 102.

A side view of the portable device 108 is shown in FIG. 3C. In some examples, the portable device 108 can be provided with a USB port (or more specifically, a mini USB port) 314, to allow the portable device 108 to be connected over a USB cable with the consumer input device 102. In other examples, the USB port 314 can be omitted.

In addition, in some examples, an on/off control element 316 (such as in the form of a slideable button) can be provided to control whether Bluetooth or other type of wireless communication is activated or deactivated. In other examples, the on/off control element 316 can be omitted.

In some examples, the portable device 108 can be provided with a card reader slot 318, to receive a payment card such as shown in FIG. 3D. The payment card 120 can be inserted through the slot 318 to allow the portable device 108 to read information from the integrated circuit card (chip card) of the payment card 120. In other examples, the card reader slot 318 can be omitted if the portable device 108 is able to wirelessly read information of the payment card 120.

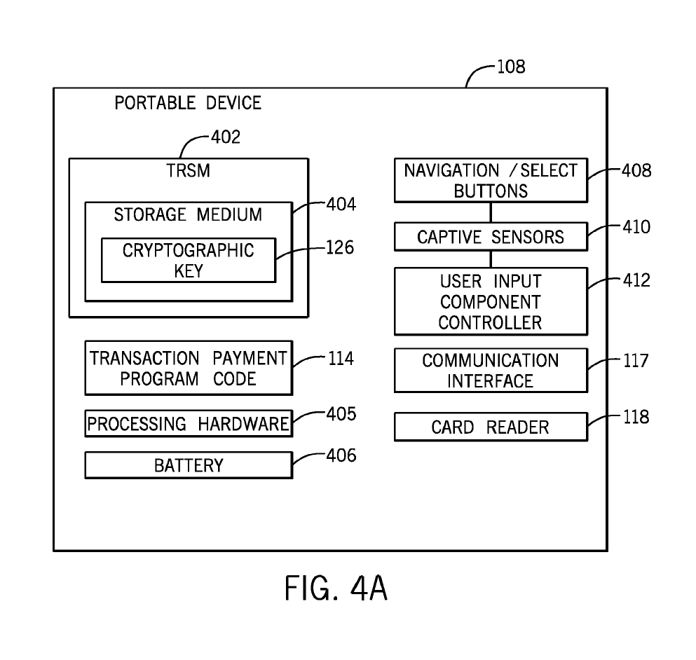

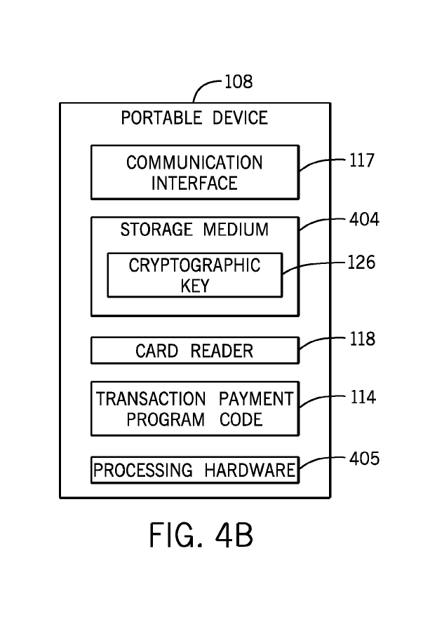

FIG. 4A is a block diagram of an example arrangement of a portable device 108 according to further implementations. The portable device 108 can include a tamper-resistant security module (TRSM) 402, which can include a storage medium 404 to store security parameters, such as the cryptographic key 126 and other cryptographic security parameters (CSPs). The TRSM 402 is tamper-resistant (to make intrusion difficult), tamper-evident (to make intrusion attempts evident), and tamper-responsive (to detect an intrusion attempt and destroy contents in the storage medium 404 in the process). As such, the TRSM 402 may be housed in a device that incorporates physical components to prevent compromise of the content inside the TRSM 402.

As further depicted in FIG. 4A, the portable device 108 also includes processing hardware 405, on which the transaction payment program code 114 is executable. In implementations where the transaction payment program code 114 is implemented as firmware, the transaction payment program code 114 can be embedded in the processing hardware 405, such as a microcontroller, an ASIC device, a PGA, and so forth.

The portable device 108 also includes a rechargeable battery 406 to provide power to electronic components of the portable device 108. Although not shown, the portable device 108 can also include a power supply that produces a power supply voltage from an external power source, such as power from the consumer endpoint device 102 when the portable device 108 is connected (wirelessly or in a wired manner) to the consumer endpoint device 102.

The portable device 108 also includes the communication interface 117 and the card reader 118. In addition, the portable device 108 includes navigation/select buttons 408 and captive sensors 410 to detect actuation of the navigation/select buttons 408.

A user input component controller 412 is in communication with the captive sensors 410 to capture actuations of the buttons and to cause communication of such actuations to the consumer endpoint device 102.

A simplified block diagram of the portable device of FIG. 4A is shown in FIG. 4B.

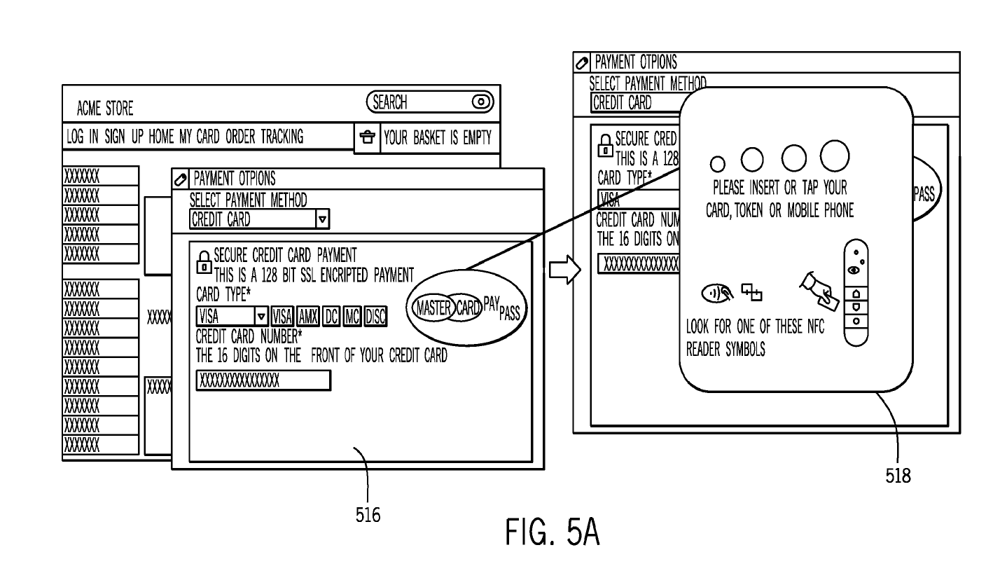

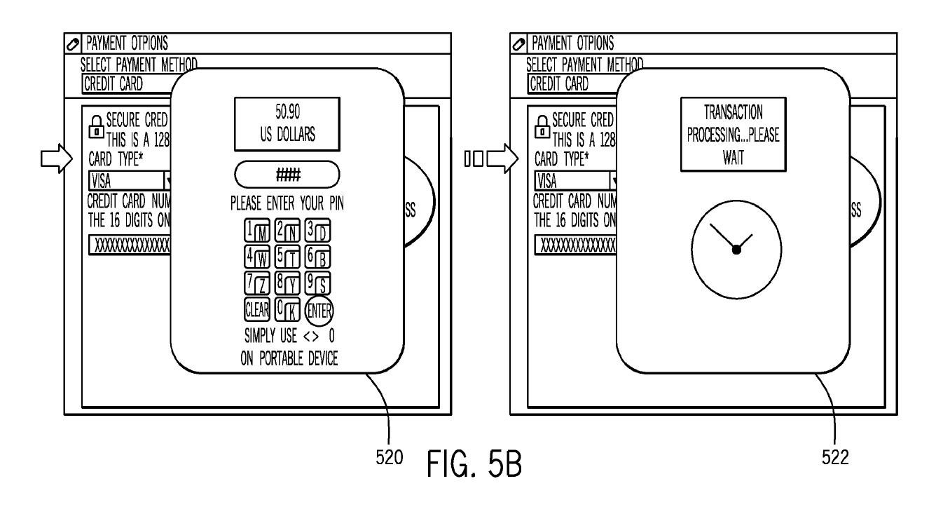

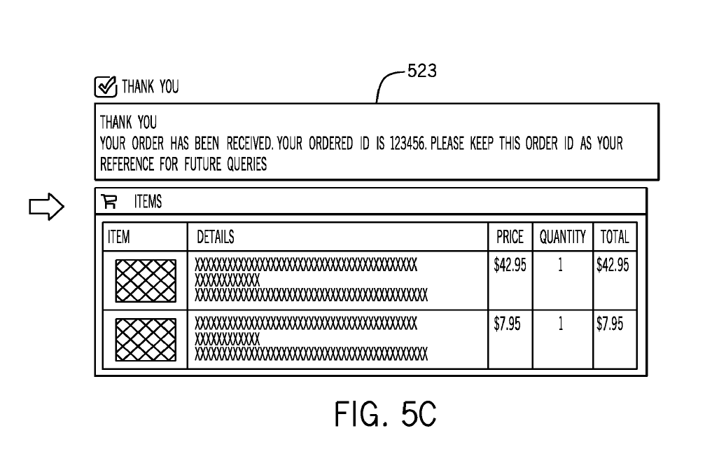

FIGS. 5A-5C illustrate an example screen flow of an example of the payment UI screen 130 (FIG. 1) for electronic funds transfer for a virtual POS, card present online transaction according to some examples. The payment UI screen 130 can include multiple working display areas presented visually and/or audibly to a user and can include user-actuatable areas. For example, the payment UI screen 130 can include working display areas in the form of a transaction processing message portion 522 and a transaction confirmation portion 523. The payment UI screen 130 can also include actuatable areas such as payment option panel 516, a payment input panel 518, and a PIN entry panel 520. In addition, the payment UI screen 130 can also include multiple operable icons to receive input to the payment UI screen 130. Other arrangements of the payment UI screen 130 can be provided in other examples.

The payment UI screen 130 can be provided using program code (machine-executable instructions) that execute on processing hardware of the consumer endpoint device 102. Inputs with respect to the payment UI screen 130 can be received through the user input component 128 of the portable device 108.

In the examples of FIGS. 5A-5C, the transaction payment program code executed by the portable device 108 can invoke the display of the payment UI screen 130 by the consumer endpoint device 102.

As shown in FIG. 5A, the payment option panel 516 prompts for a payment type entry. Payment type can include payment made by any of a credit card, a debit card, an ATM card, a payment token, a digital wallet, and so forth. The payment input panel 518 depicted in FIG. 5A can present a prompt to the user to insert or tap the payment card 120 on the portable device 108. More generally, the prompt asks the user to input the payment card 120 to the portable device, which can involve insertion of the payment card 120 in a receptacle (e.g. slot 318 in FIG. 3C), tapping the payment card 120 on a surface of the portable device 108, or bringing the payment card 120 into proximity to the portable device 108 such that wireless communication can be performed between the portable device 108 and the payment card 120.

As shown in FIG. 5B, the PIN entry panel 520 prompts for entry of a PIN by using the navigation/select buttons 408 (FIG. 4A) of the portable device 108. The transaction processing message portion 522 can display a message or messages (e.g. “transaction processing”, “please wait”, etc.) indicating the transaction is being processed.

As shown in FIG. 5C, the transaction confirmation portion 523 displays a message or messages (e.g. “your order has been received”, etc.) indicating a transaction was successful. In some examples, the message indicating the transaction was successful can also contain transaction confirmation information, e.g. an order identification number, order reference number, etc.

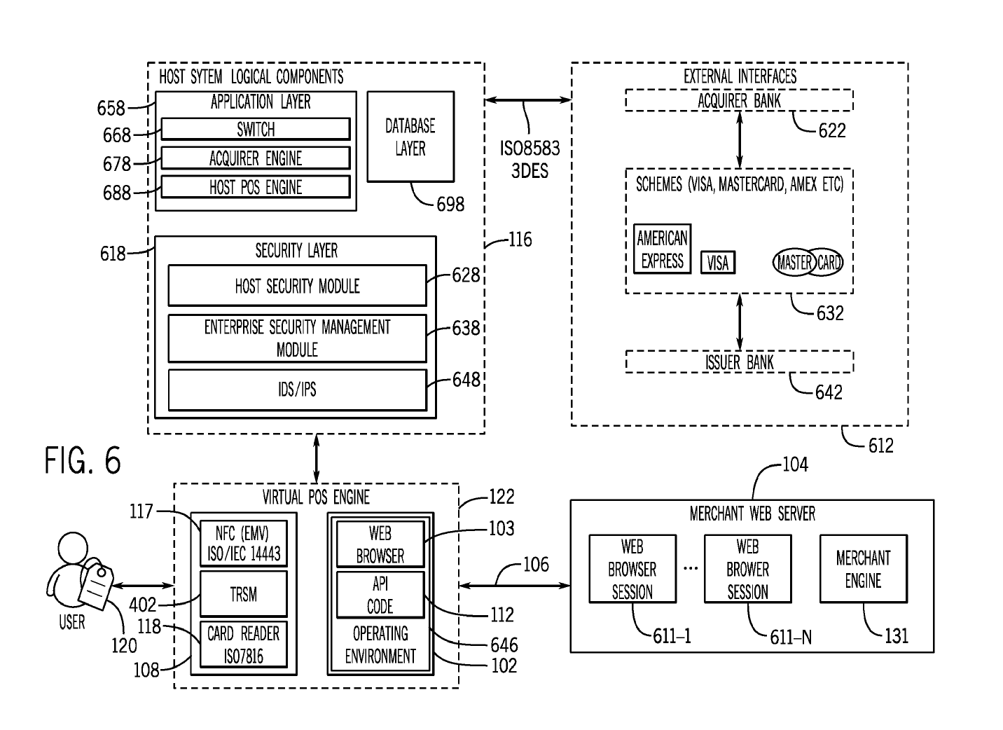

FIG. 6 illustrates an example of a logical architecture for supporting electronic funds transfer for a virtual POS, card present transaction according to some implementations of the present disclosure. As shown in FIG. 6, the virtual POS engine 122 that includes the portable device 108 and the consumer endpoint device 102 can communicate with the host system 116. The host system 116 can include a host POS engine 688 and an acquirer engine 678.

For example, the host POS engine 688 (which can include machine-executable instructions or a combination of machine-executable instructions and processing hardware) can communicate securely with the virtual POS engine 122 to transport payment credentials to the acquirer engine 678. Additionally, the host POS engine 688 can employ one or multiple security modules 628 and use a Derived Unique Key Per Transaction (DUKPT) key management scheme to ensure secure communication sessions with the virtual POS engine 122.

The acquirer engine 678 (which can include machine-executable instructions or a combination of machine-executable instructions and processing hardware) can receive a payment authorization request from the virtual POS engine 122. The term “acquirer”, as used herein, may be a third party entity associated with an electronic transaction. An acquirer may have a business relationship with a particular merchant (such as the merchant operating the merchant server 104 of FIG. 1) and can be referred to as a “merchant acquirer.” Additionally, an acquirer may be a financial intermediary that can assume the financial risk of transactions conducted by a merchant and may effect settlement on behalf of the merchant. In some instances an acquirer may have a relationship with both an issuing bank of a payment card and with a given merchant; however, in some instances an acquirer and issuing bank may be the same entity. The term “acquirer engine” is an engine performing tasks, functions and/or actions in connection with the acquirer, third party entity. The acquirer engine 678 can function to determine a scheme, e.g. Visa®, Mastercard®, Amex®, etc., associated with an issuer of a payment card, e.g. an issuing bank. By way of example, the acquirer engine 678 may determine a card scheme based on a bank identification number (BIN) or the issuer identification number (IIN) associated with a payment card.

As further shown in FIG. 6, the virtual POS engine 122 can communicate with the merchant web server 104. The host system 116 can communicate with the virtual POS engine 122, the merchant web server 104, and external interfaces 612 to facilitate electronic funds transfer at the virtual POS engine 122. The external interfaces 612 correspond to the issuer entity 124 of FIG. 1. As used herein, external interfaces include connections to servers and other third party networks such as financial institutions, etc. The merchant web server 104 can support multiple web browser sessions 611-1, . . . , 611-N that may be accessed from the virtual POS engine 122, and/or another virtual POS engine.

In some examples, the virtual POS engine 122, host system 116, and merchant web server 104 can communicate with one another using, for example, Hypertext Transfer Protocol (HTTP), secure socket layer (SSL), transport layer security (TLS), triple data encryption standard (TDES or 3DES), or any other technique. The host system 116 can communicate with the external interfaces 612 using International Organization for Standardization (ISO) 8583 and 3DES communication protocols; however, communication protocols between the host system 116 and external interfaces 612 can also employ other communication protocols, including emerging protocols such as ISO 20022, for example.

The virtual POS engine 122 (and more specifically, the portable device 108) can support the EMV® contactless specifications for payment systems as published by EMVco. For example, the portable device 108 can include NFC enabled, contactless payment capabilities, as provided by the communication interface 117. As used herein EMV® stands for Europay®, Visa®, Mastercard® and defines a global standard for inter-operation of integrated circuit cards (e.g. integrated circuit (IC) cards or “chip cards”). EMVco is an organizational body that manages, maintains and enhances EMV® integrated circuit card specifications for chip-based payment cards and acceptance devices.

The communication interface 117 of the portable device 108 can conform to the NFC)(EMV® ISO/IEC 14443 standard such that an NFC enabled, contactless payment card 120 can be read when presented to communication interface 117. The contact-based card reader 118 of the portable device 108 can also conform to the EMV Smart Card (ISO 7816) standard such that an integrated circuit card (chip card) on the payment card 120 can be read, when inserted into the slot 318 of the portable device 108. The virtual POS engine 122 can support applicable certifications, regulatory and payment body standards where relevant, including, but not restricted to, payment card industry (PCI) PIN entry device (PED), PCI PIN transaction security (PTS), EMV® Level 1 & Level 2, International Organization for Standardization/American National Standards Institute (ISO/ANSI), Federal Communications Commission (FCC), etc.

As further shown in FIG. 6, the consumer endpoint device 104 can include an operating environment 646, such as provided by a Windows® operating system, Linux® operating system, Chromium® operating system, OS X® operating system, and/or Android® operating system or any other operating system.

As shown in FIG. 6, the host system 116 can include a security layer component 618, an application layer component 658, and a database layer component 698. The security layer component 618 can include a host security module (HSM)/appliance 628, an enterprise security management module/appliance 638, and an intrusion detection system (IDS) and/or intrusion prevention system (IPS) module/appliance 648. As noted above, the host system 116 can communicate with the virtual POS engine 122 using, for example, HTTP, SSL, TLS, 3DES, etc. In this manner, the host system 116 can be remote from the virtual POS engine 122 and external interfaces 612 and exist in a cloud computing environment. The host system 116 can receive NFC enabled, contactless payment card and integrated circuit card (chip card) information direct from the virtual POS engine 122 thus avoiding having to send sensitive payment card information to the merchant server 104. The host system 116 can be payment card industry data security standard (PCI DSS) compliant.

The application layer to the host system 116 can include a switch 668 to route transaction network traffic, in addition to the acquirer engine 678 and the host POS engine 688. The acquirer engine 678 can communicate with the external interfaces 612 via the switch 668 using, for example, ISO 8583/3DES and the host POS engine 688 can communicate with the virtual POS engine 122 using, for example, HTTPS/SSL/TLS/3DES.

As shown in FIG. 6, the external interfaces 612 can include an acquirer bank entity 622 and/or an issuer bank 642 both of which may include interfaces to payment card provider payment schemes 632, e.g. Visa®, Mastercard®, Amex®, etc.

In operation, the HSM 628 in the host system 116 can include instructions executable to create, access and maintain a Base Derivation Key (BDK). The BDK can be used to create an Initial PIN Encryption Key (IPEK) which, accompanied by a key serial number, can be provided to the portable device 108. In this example, the TRSM module 402 of the portable device 108 is provided in compliance with the ISO 9564 standard and can contain a unique cryptographic key (126), e.g. IPEK, based on the HSM module 628 BDK. The IPEK can be provided to the portable device 108 at the point of manufacture such that each portable device 108 can have a unique cryptographic key 126, e.g. an IPEK accompanied by a key serial number. A subsequent Derived Unique Key Per Transaction (DUKPT), e.g. working key, can be used by the host system 116 for securing communication sessions with a given virtual POS engine 122. In some implementations, the DUKPT can be twice the bit length of the unique cryptographic key 126, e.g., the unique cryptographic key can be a 16 hexadecimal character number and the DUKPT can be a 32 hexadecimal character number.

The transaction payment program code 114 (e.g. firmware) of the portable device 108 can create a secure session between the virtual POS engine 122 and the host system 116, which has the HSM 628 containing the BDK. A secure session can ensure a validity of the virtual POS engine 122, ensure message transport encryption, e.g. 3DES, per ANSI x9.52 standards, ensure message transport authentication, e.g. via a message authentication code (MAC), and enable a secure, e.g. encrypted PIN block to be created per ANSI x9.8 and ISO 9564. The PIN block is created by encrypting a PIN entered by a user via the user input component 128 and using the cryptographic key 126 in the TRSM 402 of the portable device 108.

Additionally, the transaction payment program code 114 of the portable device 108 can include instructions that are executed to: apply a correct operating system kernel applicable to a scheme card brand, e.g. Visa®, Mastercard®, Amex®, etc.; prompt for contactless device (e.g. NFC) read, PIN entry, etc.; enrich an online purchase transaction with transaction amount, merchant ID, currency code, country code, merchant type, etc.; effect ISO 8583 messaging, e.g. message type indicator (MTI) x8xxx, x1xxx, x4xxx messages, etc.; handle exception processing; and enable updates of the transaction payment program code 114 and manual encryption key entry via an administrative function.

The host system 116 can execute instructions to securely communicate with the virtual POS engine 122 and transport payment and card credentials including the PIN block. The host system 116 can also store the Internet Protocol (IP) address and port number of the virtual POS engine 122, where this IP address and port number may be dynamically set by the merchant server 104. This assignment of the IP address and port number can effect routing of payments acquired using the virtual POS engine 122. The host system 116 can similarly be able to: effect ISO 8583 messaging, e.g. message type indicator (MTI) x8xxx, x1xxx, x4xxx messages, etc.; effect transaction routing to the merchant acquiring bank 622 or card scheme brand 632 via external interfaces 612; may effect settlement on behalf of the merchant; and can log transactional activity.

The merchant web server 104 can include a merchant engine, e.g. in the form of a servlet (machine-executable instructions), API, etc. 131 as shown in FIG. 1, to cause the system to effect a virtual POS engine 122 terminal check and present CNP, CP (contact and contactless (NFC)) options) or CNP option only. The merchant engine can cause the system to initialize a session between the virtual POS engine 122 and the host system 116, which can include capturing a source IP address, a route terminal host IP address (destination address), and referencing the host system 116. Additionally, the merchant engine can execute instructions to redirect to a CNP entry page if a virtual POS engine 122 initialization fails, e.g. the DUKPT does not match with a key held in the HSM 628 on the host system 116.

Further functionality associated with the merchant engine 131 can include: adding date/time, system trace audit number (STAN), currency code, country code, transaction amount, merchant type information, merchant identifier, etc. to an ISO 8583 MTI 0100 (e.g. authorization) message; providing a successful and unsuccessful hand off, e.g. transaction approved/declined, messages to the virtual POS engine 122; supporting error/exception conditions; and performing transaction logging.

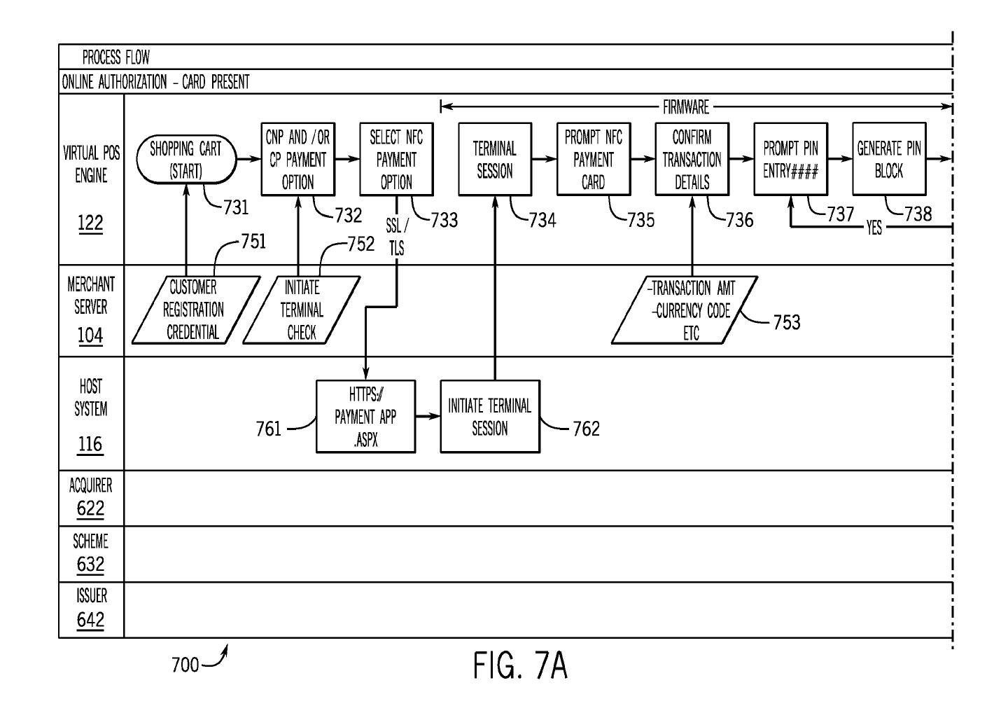

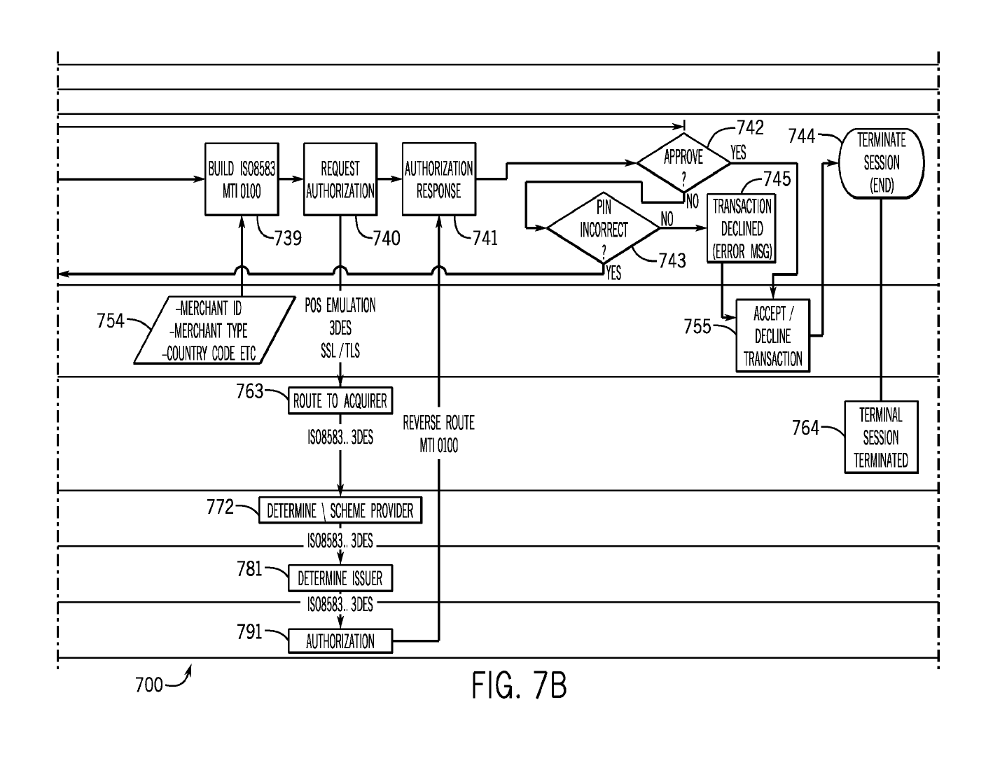

FIGS. 7A-7B illustrate an example process flow 700 for electronic funds transfer for a virtual POS, card present online transaction according to some implementations of the present disclosure. In connection with the process flow of FIGS. 7A-7B, some inputs can be received at a UI of the virtual POS engine 122. Other actions described in the process flow can result from program instructions executing to cause other components to respond further, including executing other instructions.

Further, in the example shown in FIGS. 7A-7B, multiple entities are involved, including the virtual POS engine 122 (portable device 108 and consumer endpoint device 102), a merchant server 104, a host system 116, the acquirer bank 622, the scheme 632, and the issuer bank 642. In other examples, the process flow can involve fewer or additional entities.

At 731 in FIG. 7A, a user of an online merchant website may initiate a transaction by placing items to purchase in a digital, e.g. virtual, shopping cart. As used herein, a “user” can mean a person performing or executing interactions, or multiple interactions, on the virtual POS engine 122.

At 751, the merchant server 104 can execute instructions to provide user registration credentials to the virtual POS engine 122. The merchant server 104 can initialize a secure session between the virtual POS engine 122 and host system 116 by executing instructions to capture a source IP address, route a virtual POS engine host IP address, and reference the host system 116 as part of a cloud computing service or an enterprise service, e.g. a software as a service (SaaS) application in a cloud computing environment.

At 752, the merchant server 104 can execute instructions to perform a terminal check of the virtual POS engine 122 to determine the payment capability (e.g. CNP, CP (contact and contactless (NFC)) option, or CNP option only) of the virtual POS engine 122. At 732, the virtual POS engine 122 can execute to present, e.g. offer, via a UI display, CNP and/or CP payment options. In some examples, payment capability can be determined by the merchant server 104 via an API or servlet 131. The host system 116 can receive from the virtual POS engine 122 a DUKPT (working key) to create a secure communication session between the virtual POS engine 122 and an entity (e.g. host POS engine 688) in the host system 116.

At 733, the virtual POS engine 122 can prompt a user to select a payment option, e.g. from among the CNP and/or CP payment options. Selection of the payment option is redirected (at 761) to a specified uniform resource location (URL). At 762, the merchant system 104 can initiate a terminal session between the virtual POS engine 122 and the host system 116 at 734.

At 735, the virtual POS engine 122 can present, e.g. display, a prompt (such as in the payment UI screen 130 of FIG. 1) to enter payment card information, such as by inserting or tapping the payment card 120 at the portable device 108. The virtual POS engine 122 can provide visual and/or audio confirmation that the payment credential has, or has not, been received by the virtual POS engine 122.

At 753, the merchant server 104 can forward transaction details, e.g. the amount of the transaction, a currency code for the transaction, etc. for receipt at the virtual POS engine 122. The virtual POS engine 122 can present a prompt to confirm the transaction details at 736.

At 737, the virtual POS engine 122 can receive PIN entry 737 from a user. In operation, the virtual POS engine 122 can prompt (such as with the payment UI screen 130 of FIG. 1) for PIN entry. The PIN can be entered using the user input component 128 (FIG. 1) of the portable device 108, based on a virtual PIN pad as discussed above.

At 738, the virtual POS engine 122 can encrypt the PIN, e.g. per ANSI x9.8 and ISO 9564, to generate an encrypted PIN block. At 754, the merchant server 104 can generate merchant information, e.g. country code, merchant type, merchant ID, etc., to complete a message, such as according to the ISO 8583 message format.

At 739, the virtual POS engine 122 can perform the following: add the merchant information to the PIN block; and build an ISO 8583, e.g. MTI 0100 authorization request. At 740, the virtual POS engine 122 can generate an authorization request for authorization of the electronic funds transfer, where the authorization request includes the PIN block and the payment credential of the payment card.

At 763, the virtual POS engine 122 can route the authorization request to the acquirer 622 via the host system 116. The acquirer 622 can receive the authorization request and, at 772, can execute instructions to determine the card scheme 632, e.g. Mastercard®, Visa®, Amex®, etc. using, for example, the card BIN or IIN. At 781, instructions associated with the scheme 632 can execute to determine the issuer 642, e.g. a bank that offers branded (e.g. MasterCard®, Visa®, Amex®, etc.) payment cards to consumers. In addition, at 791, the issuer 642 can provide authorization for the transaction and route an authorization response that is received, at 741, by the virtual POS engine 122. The authorization response can be, for example, an ISO 8583 MTI 0110. At 742, the virtual POS engine 122 determines if the authorization response indicates that the transaction is approved. If not approved, the virtual POS engine 122 determines, at 743, if an incorrect PIN was received, and if an incorrect PIN was received, the virtual POS engine 122 can prompt, at 737, the user to re-enter PIN information. If the virtual POS engine 122 determines, at 743, that the PIN was correct but the transaction is not approved, then the virtual POS engine 122 declines the transaction, at 745, with an error message. In response, the merchant server 104 declines, at 755, the transaction.

If the virtual POS engine 122 determines, at 742, that the authorization response indicates that the transaction is approved, the virtual POS engine 122 can accept, at 755, the transaction with the merchant server 104. More specifically, the virtual POS engine 122 can generate an indication that is provided to the merchant server 104 to complete the online transaction. In addition, at 744 and 764, the virtual POS engine 122 can terminate the session with the host system 116.

As noted above, machine-readable instructions are executable in the portable device 108, the consumer endpoint device 102, and in other devices or systems. Such machine-readable instructions are executable on processing hardware.

The machine-readable instructions can be stored on non-transitory computer-readable or machine-readable storage media. The storage media can include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
establishing, between a virtual point-of-sale (POS) engine and a host system, a secure session using a cryptographic key provided by a portable device, the secure session established through a computing device to which the portable device is in communication;
for an online transaction between the computing device and a merchant server, receiving, with the virtual POS engine comprising the portable device separate from the computing device, information of a payment card detected by a reader of the portable device;
receiving, based on activation of a user input component of the portable device with respect to a user interface displayed by the computing device, a security code; and
sending, by the virtual POS engine, a payment authorization request comprising a payment credential and the security code to the host system through the secure session.

2. The method of claim 1, wherein receiving the information of the payment card comprises receiving the information of the payment card detected wirelessly by the reader.

3. The method of claim 1, wherein receiving the information of the payment card comprises receiving the information of the payment card detected by the reader when in contact with the payment card.

4. The method of claim 1, further comprising:
detecting, by the computing device, a connection between the portable device and the computing device; and
responsive to the detected connection, downloading application programming interface code to the computing device that is executable to perform communication between the portable device and the computing device.

5. The method of claim 1, further comprising:
performing wired or wireless communication between the computing device and the portable device.

6. The method of claim 1, wherein the security code comprises a personal identification number (PIN) for the online transaction.

7. The method of claim 1, further comprising:
receiving, by the virtual POS engine, a payment authorization response responsive to the payment authorization request; and
in response to the payment authorization response, generating, by the virtual POS engine, an indication to complete the online transaction with the merchant server.

8. The method of claim 1, wherein receiving the information of the payment card comprises receiving the information of a credit card, a debit card, a smartcard, a smartphone, and a user-wearable device.

9. A portable device comprising:
a communication interface to communicate with a consumer endpoint device;
a reader to receive a payment credential of a payment card detected by the portable device, to support a virtual point-of-sale (POS), card present online transaction between the consumer endpoint device and a merchant server; and
a storage medium to store a cryptographic key;
processing hardware; and
machine-readable instructions executable on the processing hardware to:
establish a secure session with a host system using the cryptographic key,
create a personal identification number (PIN) block, and
send an authorization request comprising the payment credential and the PIN block in the secure session with the host system, seeking authorization of payment for the online transaction from an issuer entity.

10. The portable device of claim 9, further comprising a tamper-resistant security module comprising the storage medium.

11. The portable device of claim 9, further comprising:
control buttons that are user-actuatable for user input in a user interface (UI) screen displayed by the consumer endpoint device,
wherein the portable device is without any display.

12. The portable device of claim 9, wherein the machine-readable instructions are executable on the processing hardware to:
create a Derived Unique Key Per Transaction (DUKPT) from the cryptographic key, and
use the DUKPT to establish the secure session.

13. The portable device of claim 9, wherein creating the PIN block comprises creating the PIN block according to American National Standards Institute (ANSI) x9.8 and International Organization for Standardization (ISO) 9564.

14. The portable device of claim 9, wherein the machine-readable instructions are executable on the processing hardware to:
present, in a display of the consumer endpoint device, a prompt to insert or tap the payment card with respect to the portable device.
present, in the display of the consumer endpoint device, a prompt to enter a security code.

15. An article comprising at least one non-transitory machine-readable storage medium storing instructions that upon execution cause a portable device to:
establish a secure session with a host system using a cryptographic key in a tamper-resistant security module of the portable device; and
present a prompt by a consumer endpoint device with which the portable device is in communication, the prompt asking a user to input a physical payment card to the portable device;
receive, from a reader of the portable device, a payment credential from the payment card that is detected by the reader;
present a prompt by a consumer endpoint device with which the portable device is in communication, the prompt asking a user to input a security code
receive from the user a security code via user-actuatable control buttons on the portable device;
create a block by encrypting the security code using the cryptographic key; and
perform authorization of payment for the online transaction by sending the payment credential and the block in a payment authorization request through the secure session with the host system.
